(19) United States
(12) Patent Application Publication
(10) Pub. No.: US 2019/0317911 A1
(43) Pub. Date: Oct. 17, 2019

(54) GENERAL PURPOSE INPUT OUTPUT TRIGGERED INTERFACE MESSAGE

(71) Applicant: QUALCOMM Incorporated, San Diego, CA (US)

(72) Inventors: Christopher Kong Yee CHUN, Austin, TX (US); Todd Christopher REYNOLDS, Santee, CA (US); Uma Mahesh REVURI, San Diego, CA (US)

(21) Appl. No.: 16/037,802

(22) Filed: Jul. 17, 2018

Related U.S. Application Data
(60) Provisional application No. 62/659,034, filed on Apr. 17, 2018.

(51) Int. Cl. G06F 13/36; G06F 1/32

(52) U.S. Cl. CPC G06F 13/36; G06F 2213/0026; G06F 2213/0016; G06F 1/3234

(57) ABSTRACT

Systems, methods, and apparatus for communicating a control signal between device components are provided. Within an apparatus, an integrated circuit (IC) sends a control signal to a system on chip (SoC). The control signal requests enablement or disablement of one or more resources corresponding to the IC. Thereafter, a converting circuit within the SoC converts the control signal from the IC into a command to be transmitted to one or more devices. The converting circuit then transmits the command to the one or more devices via a bus coupling the SoC to the one or more devices. The one or more devices includes one or more power management integrated circuits (PMICs) configured to control the one or more resources. As such, the one or more PMICs enable or disable the one or more resources corresponding to the IC based on the command

### CROSS-REFERENCE TO RELATED APPLICATIONS

This application claims priority to and the benefit of U.S. Provisional Patent Application No. 62/659,034, filed on Apr. 17, 2018, titled “GENERAL PURPOSE INPUT OUTPUT TRIGGERED INTERFACE MESSAGE”, the entire contents of which is incorporated herein by reference.

### TECHNICAL FIELD

The present disclosure relates generally to serial communication and, more particularly, to communicating control signals between device components over a serial data link to reduce the number of hardware pins needed to connect the device components.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a serial bus or a parallel bus. General-purpose serial interfaces known in the industry include the Inter-Integrated Circuit (I2C or I²C) serial bus and its derivatives and alternatives, including interfaces defined by the Mobile Industry Processor Interface (MIPI) Alliance, such as I3C and the Radio Frequency Front-End (RFFE) interface.

General purpose input/output (GPIO) provided in an integrated circuit (IC) device enable an IC designer to define and configure pins that may be customized for particular applications. For example, a GPIO pin may be programmable to operate as an output or as an input pin depending upon a user's needs. A GPIO module or peripheral may control groups of pins which can vary based on the interface requirement. GPIO pins are commonly included in microprocessor and microcontroller applications because they offer flexibility and programmability. For example, an applications processor in mobile devices may use a number of GPIO pins to conduct handshake signaling such as inter-processor communication (IPC) with a modem processor.

In many instances, a number of command and control signals are employed to connect different component devices in mobile communication devices. These connections increase the number of general-purpose input/output (GPIO) pins within the mobile communication devices, which increases the wiring between the different component devices and an overall printed circuit board (PCB) complexity. Accordingly, it would be desirable to reduce the number of GPIO pins needed to connect the different component devices by transmitting the command and control signals over an existing serial data link

As mobile communication devices continue to include a greater level of functionality, improved techniques are needed to support low-power control signaling between components that reduce the number of GPIO pins in a mobile communication device.

### SUMMARY

Certain aspects of the disclosure relate to systems, apparatus, methods and techniques that can communicate a control signal between device components.

In various aspects of the disclosure, a method performed at an apparatus for communicating a control signal between device components is provided. The method includes sending a control signal from an integrated circuit (IC) to a system on chip (SoC), the control signal for requesting enablement or disablement of one or more resources corresponding to the IC, converting, via a converting circuit within the SoC, the control signal from the IC into a command to be transmitted to one or more devices, and transmitting the command from the converting circuit to the one or more devices via a bus coupling the SoC to the one or more devices. The one or more devices includes one or more power management integrated circuits (PMICs) configured to control the one or more resources. Accordingly, the method further includes enabling or disabling, via the one or more PMICs, the one or more resources corresponding to the IC based on the command

In an aspect, the method may also include sending a second command from a requesting PMIC of the one or more PMICs to the SoC via the bus, the second command for requesting enablement or disablement of one or more resources corresponding to the requesting PMIC and controlled by at least one controlling PMIC of the one or more PMICs, converting, via the converting circuit, the second command from the requesting PMIC into a third command to be transmitted to the at least one controlling PMIC, transmitting the third command from the converting circuit to the at least one controlling PMIC via the bus, and enabling or disabling, via the at least one controlling PMIC, the one or more resources corresponding to the requesting PMIC based on the third command

In an aspect, the IC is a circuit external to the SoC. In a further aspect, the one or more resources includes a voltage regulator regulating a voltage of the IC, a clock buffer providing a clock signal to the IC, a mode change, and/or a state change.

In an aspect, the command is a single message transmitted on the bus or multiple messages transmitted on the bus. In another aspect, the command is transmitted via the bus according to a system power management interface (SPMI) protocol.

In an aspect, the converting circuit is configured to convert the control signal into the command while a host processor of the SoC is in a sleep or low-power state. In a further aspect, the converting circuit is configured to convert the control signal into the command by translating a signal transition of the control signal into a stream of bits representing the command.

In an aspect, the IC includes the one or more PMICs. In another aspect, the command is transmitted from the converting circuit to the one or more PMICs via an arbiter circuit/module that provides access to the one or more PMICs. In a further aspect, the command is a global command transmitted to all PMICs of the one or more PMICs, or a command transmitted to a core PMIC of the one or more PMICs, wherein the core PMIC includes a PMIC controller for routing the command to at least one PMIC of the one or more PMICs intended to receive the command

In another aspect of the disclosure, an apparatus for communicating a control signal between device components is provided. The apparatus includes one or more devices, a system on chip (SoC), a bus coupling the SoC to the one or more devices, an integrated circuit (IC) configured to send a control signal to the SoC, the control signal for requesting enablement or disablement of one or more resources corresponding to the IC, and a converting circuit formed within the SoC and configured to convert the control signal from the IC into a command and transmit the command to the one or more devices via the bus.

In an aspect, the one or more devices includes one or more power management integrated circuits (PMICs) configured to control the one or more resources, wherein the one or more PMICs enable or disable the one or more resources corresponding to the IC based on the command In a further aspect, a requesting PMIC of the one or more PMICs is configured to send a second command to the SoC via the bus, the second command for requesting enablement or disablement of one or more resources corresponding to the requesting PMIC and controlled by at least one controlling PMIC of the one or more PMICs, the converting circuit is configured to convert the second command from the requesting PMIC into a third command and transmit the third command to the at least one controlling PMIC via the bus, and the at least one controlling PMIC is configured to enable or disable the one or more resources corresponding to the requesting PMIC based on the third command.

In a further aspect of the disclosure, an apparatus for communicating a control signal between device components is provided. The apparatus includes means for sending a control signal from an integrated circuit (IC) to a system on chip (SoC), the control signal for requesting enablement or disablement of one or more resources corresponding to the IC, means for converting, within the SoC, the control signal from the IC into a command to be transmitted to one or more devices, and means for transmitting the command from the means for converting to the one or more devices via a bus coupling the SoC to the one or more devices. In an aspect, the one or more devices includes one or more power management integrated circuits (PMICs) configured to control the one or more resources. As such, the apparatus may further include means for enabling or disabling, via the one or more PMICs, the one or more resources corresponding to the IC based on the command.

In another aspect of the disclosure, a non-transitory computer-readable medium storing computer-executable code at an apparatus for communicating a control signal between device components. The apparatus includes code for causing a computer to send a control signal from an integrated circuit (IC) to a system on chip (SoC), the control signal for requesting enablement or disablement of one or more resources corresponding to the IC, convert, within the SoC, the control signal from the IC into a command to be transmitted to one or more devices, and transmit the command to the one or more devices via a bus coupling the SoC to the one or more devices. In an aspect, the one or more devices includes one or more power management integrated circuits (PMICs) configured to control the one or more resources. As such, the non-transitory computer-readable medium further includes code for causing the computer to enable or disable, via the one or more PMICs, the one or more resources corresponding to the IC based on the command.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device that employs an RFFE bus to couple various radio frequency front-end devices.

FIG. 4 illustrates an apparatus that includes an Application Processor and multiple peripheral devices that may be adapted according to certain aspects disclosed herein.

FIG. 5 illustrates a system that employs physical GPIO pins for a variety of purposes.

FIG. 6 illustrates an example of a system which includes one or more communication links that employ sideband GPIO.

FIG. 7 is a diagram illustrating an example architecture for communicating signals between devices.

FIG. 8 is a diagram illustrating another example architecture for communicating signals between devices according to aspects of the present disclosure.

FIG. 9 is a diagram illustrating an example on-SoC architecture for communicating signals between devices according to aspects of the present disclosure.

FIG. 10 is a flowchart of a method that may be performed at a device for communicating a control signal between device components according to aspects of the present disclosure.

FIG. 11 is a diagram illustrating a simplified example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include multiple SoC and other IC devices often employ a shared communication interface that may include a serial bus or other data communication link to connect processors with modems and other peripherals. The serial bus or other data communication link may be operated in accordance with multiple standards or protocols defined. In one example, a serial bus may be operated in accordance with I2C, I3C, SPMI, and/or RFFE protocols.

A number of different protocol schemes may be used for reducing a number of GPIO pins needed to connect different component devices by transmitting command and/or control signals between the different component devices over an existing serial data link Existing protocols have well-defined and immutable structures in the sense that their structures cannot be changed to optimize transmission latencies based on variations in use cases, and/or coexistence with other protocols, devices and applications. It is an imperative of real-time embedded systems that certain deadlines be met. In certain real-time applications, meeting transmission deadlines is of paramount importance. When a common bus supports different protocols it is generally difficult or impossible to guarantee optimal latency under all use cases. In some examples, an I2C, I3C, RFFE, or System Power Management Interface (SPMI) serial communication bus may be used to tunnel different protocols with different latency requirements, different data transmission volumes, and/or different transmission schedules.

Certain aspects disclosed herein provide methods, circuits, and systems that are adapted to communicate control signals between device components over a serial data link. The disclosed techniques allow a device to support low-power control signaling between the device components while reducing the number of GPIO pins in the device.

Examples Of Apparatus That Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

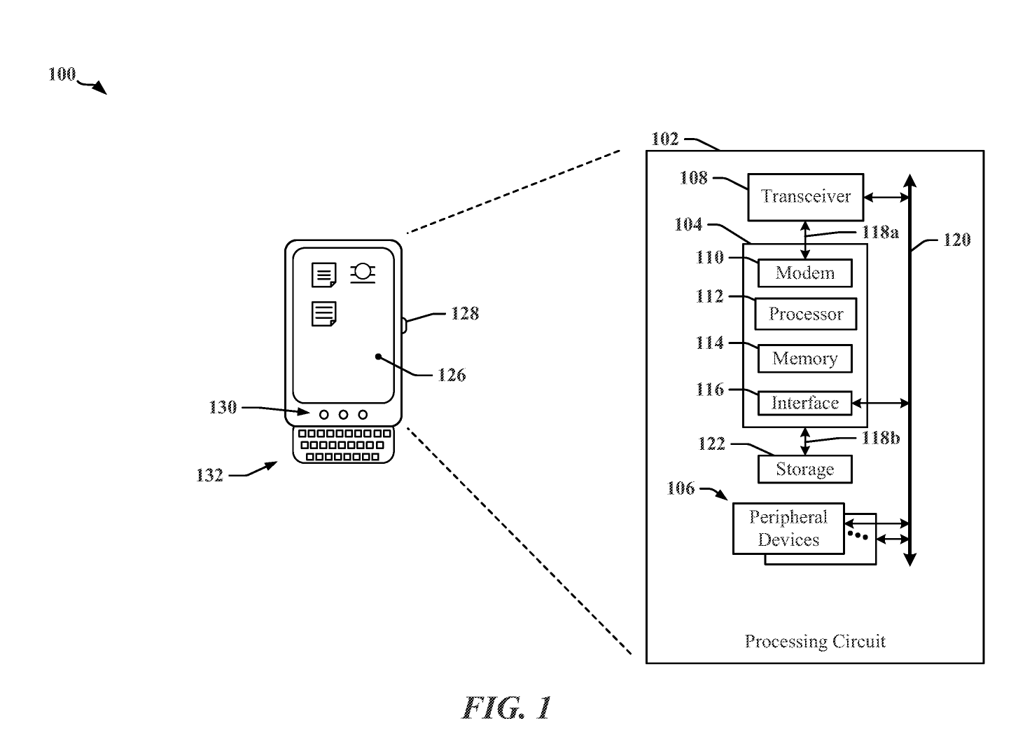

FIG. 1 illustrates an example of an apparatus 100 that may employ a data communication bus. The apparatus 100 may include a processing circuit 102 having multiple circuits or devices 104, 106, and/or 108, which may be implemented in one or more application-specific integrated circuits (ASICs) or in a SoC. In one example, the apparatus 100 may be a communication device and the processing circuit 102 may include a processing device provided in an ASIC 104, one or more peripheral devices 106, and a transceiver 108 that enables the apparatus to communicate with a radio access network, a core access network, the Internet, and/or another network.

The ASIC 104 may have one or more processors 112, one or more modems 110, on-board memory 114, a bus interface circuit 116, and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database, a cloud-based storage, or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as a display 126, operator controls, such as switches or buttons 128, 130, and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic, and other configurable circuits or modules. In one example, the bus interface circuit 116 may be configured to operate in accordance with communication specifications or protocols. The processing circuit 102 may include or control a power management function that configures and manages the operation of the apparatus 100.

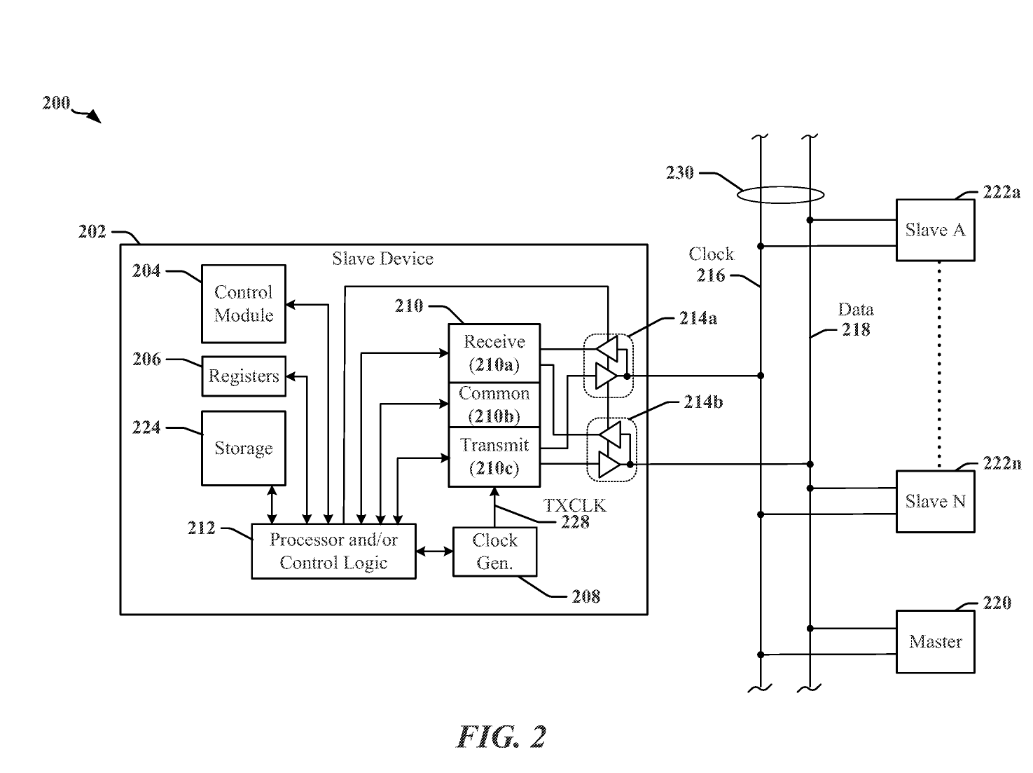

FIG. 2 illustrates certain aspects of an apparatus 200 that includes multiple devices 202, 220, and 222a-222n connected to a serial bus 230. The devices 202, 220, and 222a-222n may include one or more semiconductor IC devices, such as an applications processor, SoC or ASIC. Each of the devices 202, 220, and 222a-222n may include, support or operate as a modem, a signal processing device, a display driver, a camera, a user interface, a sensor, a sensor controller, a media player, a transceiver, and/or other such components or devices. Communications between devices 202, 220, and 222a-222n over the serial bus 230 are controlled by a bus master 220. Certain types of bus can support multiple bus masters 220.

The apparatus 200 may include multiple devices 202, 220, and 222a-222n that communicate when the serial bus 230 is operated in accordance with I2C, I3C, or other protocols. At least one device 202, 222a-222n may be configured to operate as a slave device on the serial bus 230. In one example, a slave device 202 may be adapted to provide a control function 204. In some examples, the control function 204 may include circuits and modules that support a display, an image sensor, and/or circuits and modules that control and communicate with one or more sensors that measure environmental conditions. In other examples, the control function 204 may include circuits and modules that support a radio, RF sensor, and/or circuits and modules that control and communicate with one or more devices external to the apparatus 200. The slave device 202 may include configuration registers 206 or other storage 224, control logic 212, a transceiver 210 and line drivers/receivers 214a and 214b. The control logic 212 may include a processing circuit such as a state machine, sequencer, signal processor, or general-purpose processor. The transceiver 210 may include a receiver 210a, a transmitter 210c, and common circuits 210b, including timing, logic, and storage circuits and/or devices. In one example, the transmitter 210c encodes and transmits data based on timing in one or more signals 228 provided by a clock generation circuit 208.

Two or more of the devices 202, 220, and/or 222a-222n may be adapted according to certain aspects and features disclosed herein to support a plurality of different communication protocols over a common bus, which may include an I2C, I3C and/or SPMI protocol. In some instances, devices that communicate using the I2C protocol can coexist on the same 2-wire interface with devices that communicate using the I3C protocol. In one example, the I3C protocols may support a mode of operation that provides a data rate between 6 megabits per second (Mbps) and 16 Mbps with one or more optional high-data-rate (HDR) modes of operation that provide higher performance The I2C protocols may conform to de facto I2C standards providing for data rates that may range between 100 kilobits per second (kbps) and 3.2 megabits per second (Mbps). I2C, I3C and SPMI protocols may define electrical and timing aspects for signals transmitted on the 2-wire serial bus 230, in addition to data formats and aspects of bus control. In some aspects, the I2C, I3C, and SPMI protocols may define direct current (DC) characteristics affecting certain signal levels associated with the serial bus 230, and/or alternating current (AC) characteristics affecting certain timing aspects of signals transmitted on the serial bus 230. In some examples, a 2-wire serial bus 230 transmits data on a first wire 218 and a clock signal on a second wire 216. In some instances, data may be encoded in the signaling state, or transitions in signaling state of the first wire 218 and the second wire 216.

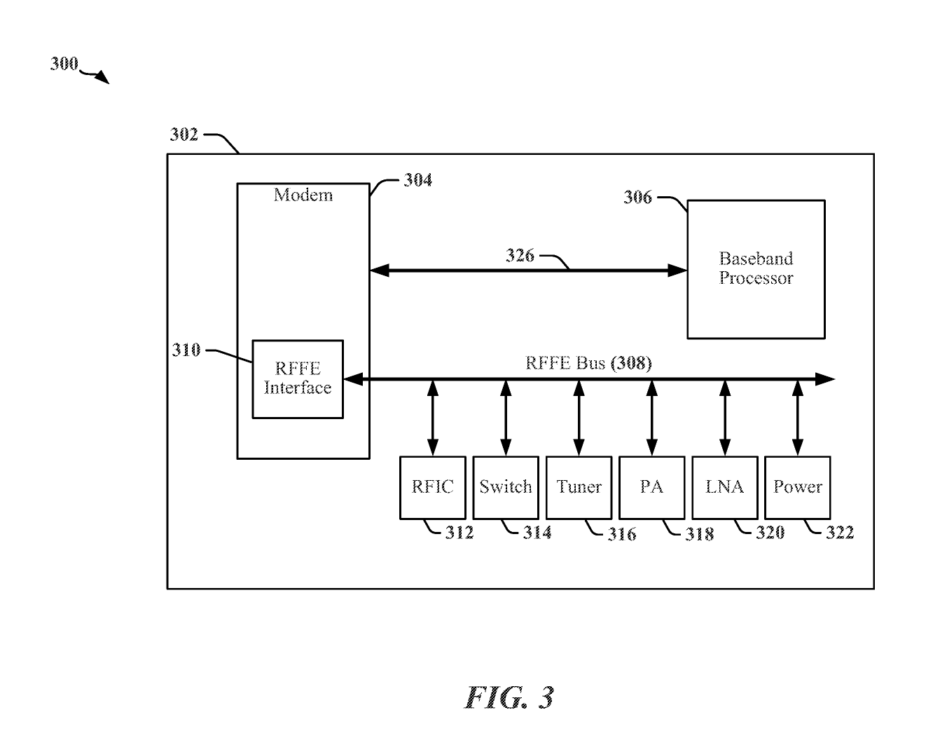

FIG. 3 is a block diagram 300 illustrating an example of a device 302 that employs an RFFE bus 308 to couple various front-end devices 312, 314, 316, 318, 320, 322. Although the device 302 will be described with respect to an RFFE interface, it is contemplated that the device 302 may also apply to a system power management interface (SPMI) and other multi-drop serial interfaces. A modem 304 may include an RFFE interface 310 that couples the modem 304 to the RFFE bus 308. The modem 304 may communicate with a baseband processor 306. The illustrated device 302 may be embodied in one or more of a mobile communication device, a mobile telephone, a mobile computing system, a mobile telephone, a notebook computer, a tablet computing device, a media player, a gaming device, a wearable computing and/or communications device, an appliance, or the like. In various examples, the device 302 may be implemented with one or more baseband processors 306, modems 304, multiple communications links 308, 326, and various other buses, devices and/or different functionalities. In the example illustrated in FIG. 3, the RFFE bus 308 may be coupled to an RF integrated circuit (RFIC) 312, which may include one or more controllers, and/or processors that configure and control certain aspects of the RF front-end. The RFFE bus 308 may couple the RFIC 312 to a switch 314, an RF tuner 316, a power amplifier (PA) 318, a low noise amplifier (LNA) 320, and a power management module 322.

GPIO Signaling

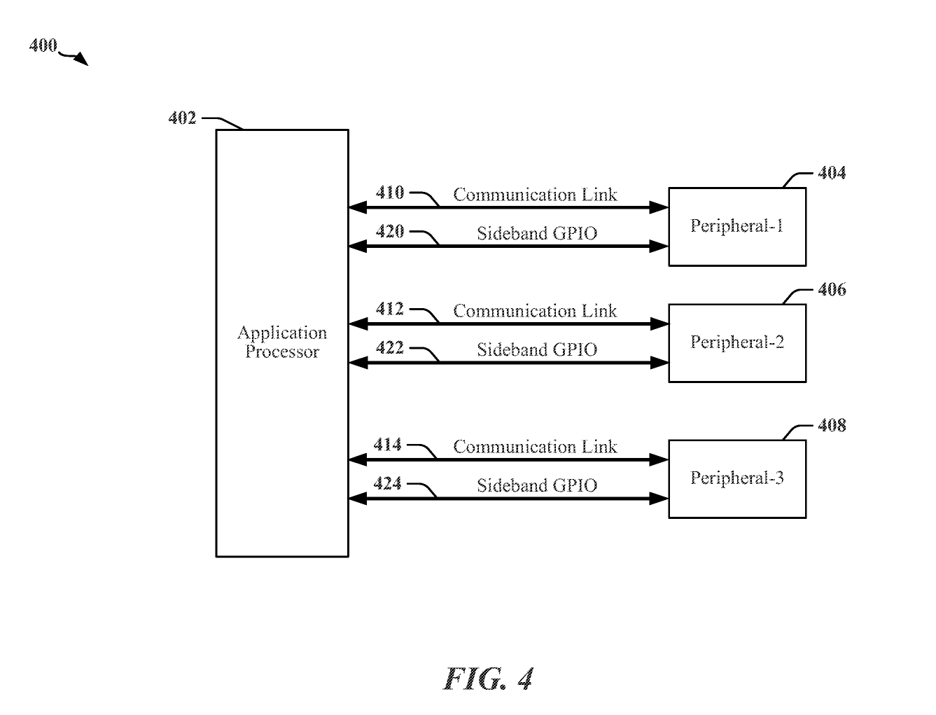

Mobile communication devices, and other devices that are related or connected to mobile communication devices, increasingly provide greater capabilities, performance and functionalities. In many instances, a mobile communication device incorporates multiple IC devices that are connected using a variety of communications links FIG. 4 illustrates an apparatus 400 that includes an Application Processor 402 and multiple peripheral devices 404, 406, 408. In the example, each peripheral device 404, 406, 408 communicates with the Application Processor 402 over a respective communication link 410, 412, 414 operated in accordance with mutually different protocols. Communication between the Application Processor 402 and each peripheral device 404, 406, 408 may involve additional wires that carry control or command signals between the Application Processor 402 and the peripheral devices 404, 406, 408. These additional wires may be referred to as sideband general purpose input/output (sideband GPIO 420, 422, 424), and in some instances the number of connections needed for sideband GPIO 420, 422, 424 can exceed the number of connections used for a communication link 410, 412, 414.

GPIO provides generic pins/connections that may be customized for particular applications. For example, a GPIO pin may be programmable to function as an output, input pin or a bidirectional pin, in accordance with application needs. The term “pin,” as used herein, may refer to a physical structure such as a pad, pin or other interconnecting element used to couple an IC to a wire, trace, through-hole via, or other suitable physical connector provided on a circuit board, substrate, flex cable, board connector, or the like.

In one example, the Application Processor 402 may assign and/or configure a number of GPIO pins to conduct handshake signaling or inter-processor communication (IPC) with a peripheral device 404, 406, 408 such as a modem. When handshake signaling is used, sideband signaling may be symmetric, where signaling is transmitted and received by the Application Processor 402 and a peripheral device 404, 406, 408. With increased device complexity, the increased number of GPIO pins used for IPC communication may significantly increase manufacturing cost and limit GPIO availability for other system-level peripheral interfaces.

According to certain aspects, the state of GPIO, including GPIO associated with a communication link, may be captured, serialized and transmitted over a data communication link In one example, captured GPIO may be transmitted in packets over an I3C bus using common command codes to indicate packet content and/or destination.

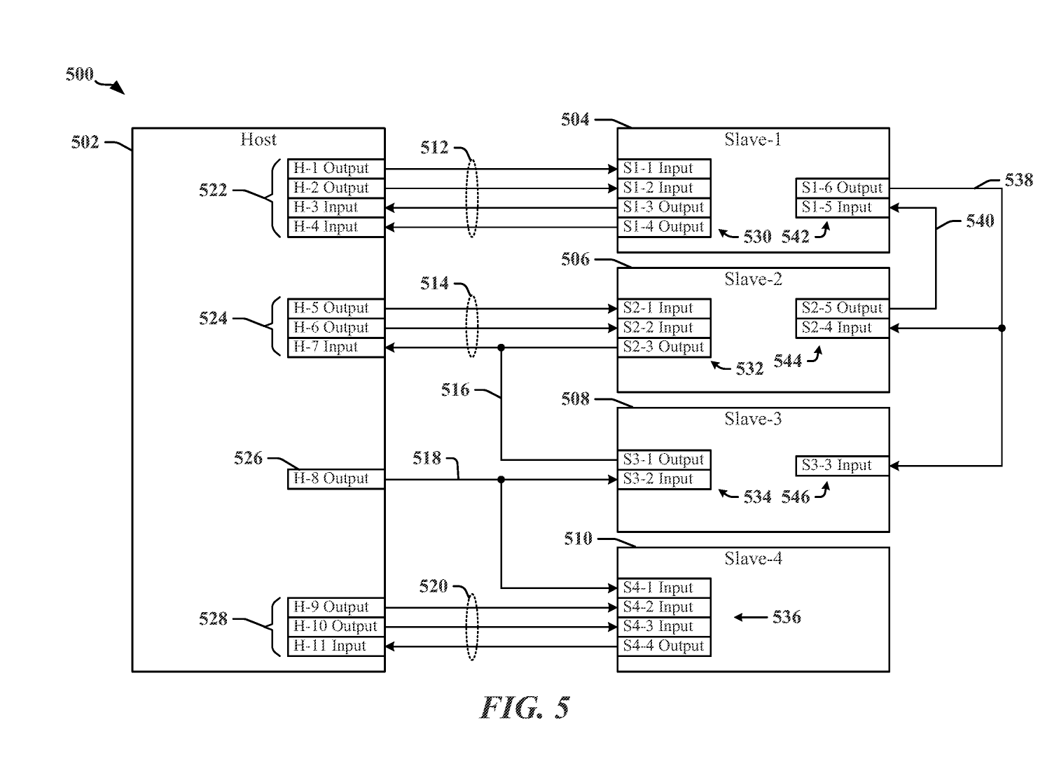

FIG. 5 illustrates a system 500 that employs physical GPIO pins for a variety of purposes. Although not shown in FIG. 5 (but see FIG. 4), the system 500 may include one or more communication links and certain physical GPIO pins may be assigned to support out-of-band signaling associated with the communication links, while other physical GPIO pins may be used for other purposes. Physical GPIO pins may enable signals to be transmitted over wires 512, 514, 516, 518, 520 connecting two or more devices 502, 504, 506, 508, 510. The signals may include interrupt signals, enable/disable signals, ready/not-ready signals, synchronization signals, low-speed serial clock and/or data signals, and/or status signals such as data buffer condition or activity status, coexistence signals indicating when one of a plurality of radio frequency transceivers is actively transmitting or receiving.

The illustrated system 500 includes a host device 502 and multiple slave devices 504, 506, 508, 510. In one example, the host device 502 incorporates an Application Processor 402 (see FIG. 4) configured to service, configure, control and/or support operation of one or more slave devices 504, 506, 508, 510. In another example, the host device 502 may be configured to operate as a bus master on one or more communication links that couple the host device 502 to some or all of the slave devices 504, 506, 508, 510. In FIG. 5, the host device 502 is coupled to each of the slave devices 504, 506, 508, 510.

First host GPIO 522 couples the host device 502 through a first connector configuration 512 to corresponding first slave GPIO 530 in a first slave device 504. The first host GPIO 522 may include GPIO pins configured as an input, an output or a bidirectional pin, with corresponding first slave GPIO 530 being configured to match the type of signaling transmitted over connectors in the first connector configuration 512. Some GPIO pins may be configured to be placed in a high-impedance state. In one example, the first slave device 504 may include an imaging device or display controller, and image and/or video data may be exchanged through a high-speed communication link 410 (see FIG. 4). In this example, the first host GPIO 522 and first slave GPIO 530 may include sideband GPIO 420 that enables control signaling in both directions between the host device 502 and the first slave device 504.

Second host GPIO 524 couples the host device 502 through a second connector configuration 514 to corresponding second slave GPIO 532 in a second slave device 506. The second host GPIO 524 may include GPIO pins configured as an input, an output or a bidirectional pin. Some GPIO pins may be configured to be placed in a high-impedance state, with corresponding second slave GPIO 532 being configured to match the type of signaling transmitted over connectors in the second connector configuration 514. In the illustrated example, a connector 516 coupling the second host GPIO 524 with the second slave GPIO 532 may be connected to third slave GPIO 534 in a third slave device 508. The connector 516 may, for example, carry an interrupt signal and may be driven by open-drain GPIO in the second slave device 506 or the third slave device 508.

Third host GPIO 526 couples the host device 502 through a third connector configuration 518 to corresponding GPIO pins in the third slave GPIO 534 in the third slave device 508, and a GPIO pin in fourth slave GPIO 536 in a fourth slave device 510. In one example, the connector 518 may carry a synchronizing signal from the host device 502 to the second slave device 506 and the third slave device 508. In another example, the connector 518 may carry an enable/disable signal from the host device 502 to the second slave device 506 and the third slave device 508. In another example, the connector 518 may carry a select signal used by the host device 502 to select between the second slave device 506 and the third slave device 508.

Fourth host GPIO 528 couples the host device 502 through a fourth connector configuration 520 to corresponding pins in the fourth slave GPIO 536 in the fourth slave device 510. The fourth host GPIO 528 may include GPIO pins configured as an input, an output or a bidirectional pin, with corresponding fourth slave GPIO 536 being configured to match the type of signaling transmitted over connectors in the fourth connector configuration 520. Some GPIO pins may be configured to be placed in a high-impedance state.

Additional slave GPIO 542, 544, 546 may be provided in certain slave devices 504, 506, 508 to support signaling between the slave devices 504, 506, 508 over connectors 538, 540 that are not coupled to the host device 502. Signaling between slave devices 506, 508, 510 may also occur on the connectors 516 and 518 coupled to the host device 502. Some connectors 516, 518, 538 support multi-drop or multipoint signaling where signals generated at a first device are received by multiple devices. In some instances, the connectors 516, 518, 538 may support multi-drive signaling where signals can be generated at one or more devices.

Certain aspects disclosed herein enable GPIO state generated on different devices to be communicated across a multi-drop bus, such that physical interconnections between different groups or pairs of devices can be eliminated.

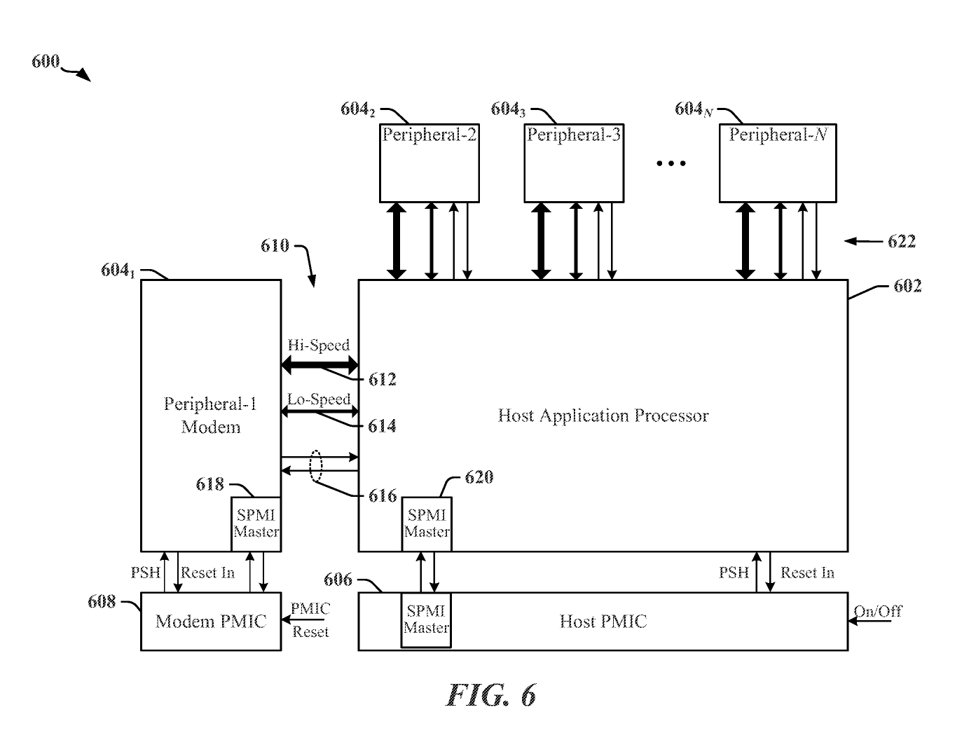

FIG. 6 illustrates an example of a system 600 which includes one or more communication links that employ sideband GPIO. To facilitate description, the example of a serial data link may be employed, although the concepts described herein may be applied to parallel data communication links The system 600 may include an application processor 602 that may serve as a host device on various communication links, multiple peripherals 604₁-604_{N}, and one or more power management integrated circuits (PMICs 606, 608). In the illustrated system 600, at least a first peripheral 604₁ may include a modem. The application processor 602 and the first peripheral 604₁ may be coupled to respective PMICs 606, 608 using GPIO that provides a combination of reset and other signals, and a system power management interface (SPMI 618, 620). The SPMI 618, 620 operates as a serial interface defined by the MIPI Alliance that is optimized for the real-time control of devices including PMICs 606, 608. The SPMI 618, 620 may be configured as a shared bus that provides high-speed, low-latency connection for devices, where data transmissions may be managed, according to priorities assigned to different traffic classes.

The application processor 602 may be coupled to each of the peripherals 604₁-604_{N} using multiple communication links 612, 614 and GPIO 616. For example, the application processor 602 may be coupled to the first peripheral 604₁ using a high-speed bus 612, a low-speed bus 614, and input GPIO 616.

GPIO Triggered Interface Message

In the field of chipsets, GPIO pins may be used to communicate information via hardware signals between chips. For example, the GPIO pins may be used to facilitate the communication of PMIC regulator and clock control signals for devices in various chipsets. Some chips/triggers that may utilize the GPIO pins include WLAN delivery traffic indication map (DTIM), BT ACK/connection, NFC Field sense/activity, WiGig (802.11ad) DTIM, USB connector attach, battery insertion/removal, SIM card insertion/removal, SD card insertion/removal, and external sensor detection event (e.g., camera, touch, audio, gyro, etc.).

In an aspect, numerous hardware signals are transmitted throughout a chipset to convey simple information from one chip to another. As a number of signals required to be communicated in the chipset increases, a number of GPIO pins on a chip, as well as printed circuit board (PCB) routing between chips, also increases. However, as chipsets become more advanced, die area is decreasing. Therefore, an amount of die space for accommodating the GPIO pins to communicate the hardware signals is limited.

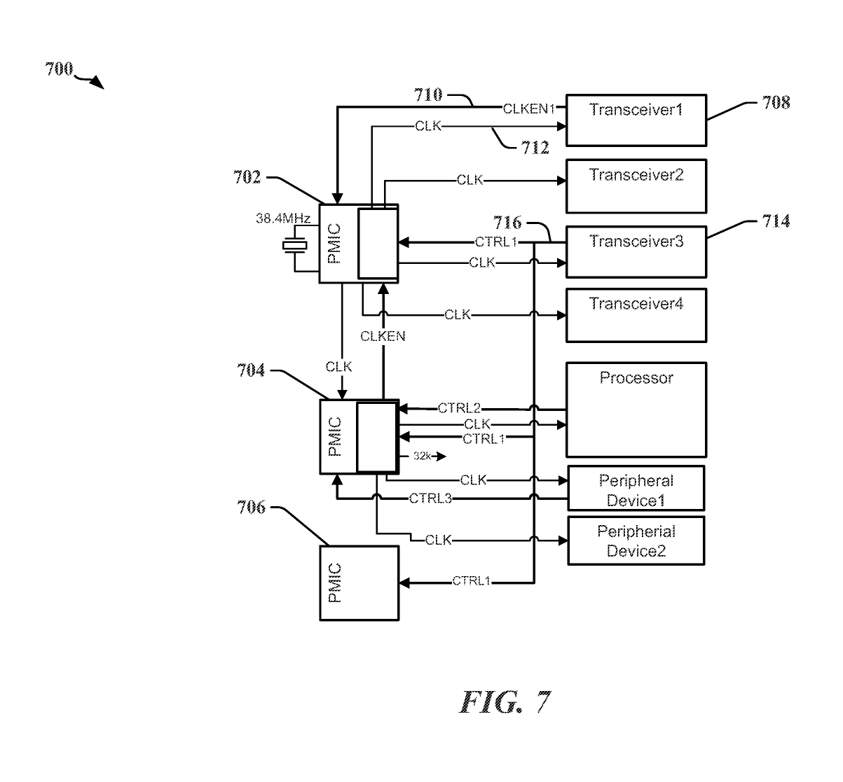

FIG. 7 is a diagram illustrating an example architecture 700 for communicating signals between devices (or device components). As technology advances, power management integrated circuits (PMICs) (e.g., first PMIC 702, second PMIC 704, and third PMIC 706) and packages are becoming smaller in size. Consequently, a number of GPIO pins to communicate hardware control signals to and from the PMICs, such as for enabling clocks, enabling regulators, etc., is also decreasing. As such, aspects of the present disclosure relate to eliminating as many hardware signals/GPIO pins as possible without sacrificing the amount or types of information capable of being communicated between devices. In an aspect, the present disclosure is directed toward the PMIC area, but may be applied to other device areas as well.

Referring to FIG. 7, a control signal transmitted from a chip may indicate to a PMIC that an action is to be performed by the PMIC. The PMIC may enable a corresponding action (e.g., enable a clock, enable a voltage regulator, enable a mode/state change, etc.) based on the control signal received from the chip. In an aspect, a wide variety of actions may occur in the PMIC when the control signal from the chip transitions to a high state or to a low state.

In one example operation, a first chip (Transceiver1) 708 is an independent chip that is operating. When the first chip 708 decides that it needs its clock, the first chip 708 may assert a hardware signal via a first clock enable line (CLKEN1) 710 connected to a first PMIC 702. For example, the first chip 708 asserts the hardware signal by raising a voltage of the first clock enable line 710 to 1.8V. The first PMIC 702 will then receive the hardware signal and determine that the first chip 708 has requested its clock. In response, the first PMIC 702 will enable a corresponding clock for the first chip 708. As shown in FIG. 7, a clock of 38.4 MHz (712) is enabled for the first chip 708. Furthermore, when the first chip 708 no longer needs its clock, the first chip 708 may de-assert the first clock enable line 710 and the first PMIC 702 may disable the corresponding clock accordingly.

In another example operation, a first control line (CTRL1) 716 may not only enable clocks, but may also enable voltage regulators. Accordingly, when a second chip (Transceiver3) 714 decides that it needs its clock/voltage regulator to be enabled, the second chip 714 may assert a hardware signal via the first control line 716. In this example, the first control line 716 is connected to two PMICs, the first PMIC 702 and the third PMIC 706, as there may exist two regulators (one regulator in each PMIC) that need to be enabled in order to support the second chip 714. The first PMIC 702 and the third PMIC 706 will then receive the hardware signal and determine that the second chip 714 has requested its clock/regulator to be enabled. In response, the first PMIC 702 and the third PMIC 706 will enable a corresponding clock/regulator for the second chip 714. When the second chip 714 no longer needs its clock/regulator enabled, the second chip 714 may de-assert the first control line 716 and the first PMIC 702 and the third PMIC 706 may disable the corresponding clock/regulator accordingly.

External chips may need regulators and/or clocks for powering on/off, mode selection, and sequencing, for example. The regulators and/or clocks may also be needed when a main system on chip (SoC) is in a sleep or low power state. The external chips may route dedicated signals to PMIC hardware (GPIO) pins to control the regulators and clocks. However, a number of pins on the PMICs may be limited. Therefore, the elimination of pins can save PMIC system costs. Moreover, because control signals route to all PMICs having resources requiring control, and routing the control signals through a SoC/PMIC area is constrained, the elimination of routing can reduce PCB complexity.

In an aspect of the disclosure, control signal routing is facilitated via a SoC instead of routing through each individual PMIC. The SoC includes an existing signal path for data communication between the SoC and a PMIC. Accordingly, the existing signal path may be leveraged to also communicate a control signal from an external IC (external to the SoC) to the PMIC. For example, the control signal may be converted into an SPMI transaction, which then triggers in a core PMIC a sequence that may be run. This may include control of all resources controlled by the PMICs. In an aspect, the core PMIC may include a controller that controls from a single point all PMICs and the resources associated with them. Accordingly, a number of GPIO pins and PCB routing complexity is reduced.

In previous architectures, pins are routed to individual PMICs. Therefore, if three different chips/devices wanted to communicate with three different PMICs, for example, a total of nine separate signal routes may be needed to support all communications. In contrast, by routing the control signaling through the SoC instead of through each individual PMIC according to the aspects of the present disclosure, the number of signal rounds may be reduced to three. Moreover, as chipsets evolve, PMICs may become more discrete. Therefore, the ability to route control signals through a single entity (e.g., SoC) would allow communications to be distributed to the discrete PMICs and provide significant benefits.

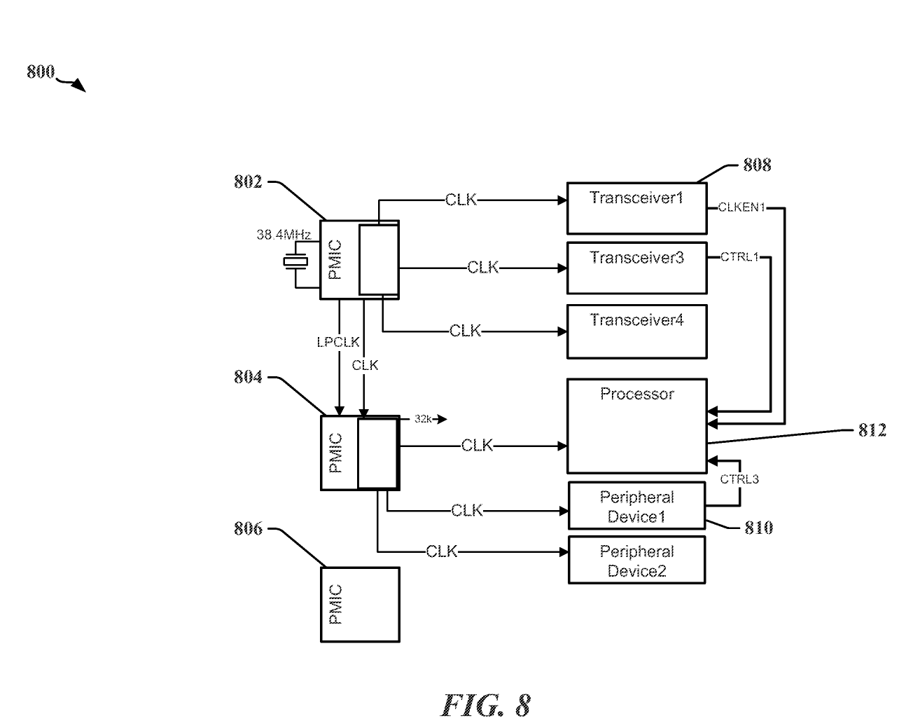

FIG. 8 is a diagram illustrating another example architecture 800 for communicating signals between devices. In an aspect, hardware control signals requesting actions may be sent to SoC GPIO pins, and the SoC may send an SPMI message to a PMIC subsystem to control corresponding resources (e.g., voltage regulators and clocks). In more detail, as shown in FIG. 8, instead of routing control signals from various chips/devices (e.g. first chip (Transceiver1) 808 and/or second chip (Peripheral Device1) 810) to individual PMICs (e.g., first PMIC 802, second PMIC 804, and/or third PMIC 806), the control signals may be routed to the SoC (Processor) 812. The SoC 812 may then trigger an SPMI message to one or more PMICs for voltage regulator and clock control. In an aspect, a conversion engine, such as an interface circuit/module (e.g., a Multi-Generic event PMIC arbiter Interface (MGPI) circuit/module), within the SoC may be functional when the SoC is in a low power/sleep state. As such, the interface circuit/module may operate to handle the control signals from the various chips without waking, or causing a higher power state in, the SoC. The interface circuit/module is capable of controlling resources on multiple PMICs.

In an aspect, all of the hardware control signals (requesting actions) that were previously routed between all of the different PMICs and chips/devices are brought together and routed into the SoC 812. The SoC 812 may send a control command to a core PMIC (e.g., one of PMICs 802, 804, 806) by leveraging an existing communication bus (e.g., SPMI bus) between the SoC 812 and the core PMIC. The core PMIC may aggregate all of the different hardware signals requesting actions and send the requests to individual PMICs.

In an aspect, a global control command may be sent to all of the PMICs. In another example, a control command may be sent to a PMIC controller that can route control signals to all PMICs intended to receive the control command Accordingly, the control command may be sent to the core PMIC having the PMIC controller, or the control command may be sent to all of the individual PMICs on a shared communication bus. In an aspect, the hardware control signals from individual chips/devices (i.e., individual signal edges) are converted into commands via the SoC, and the commands are transmitted on a shared bus.

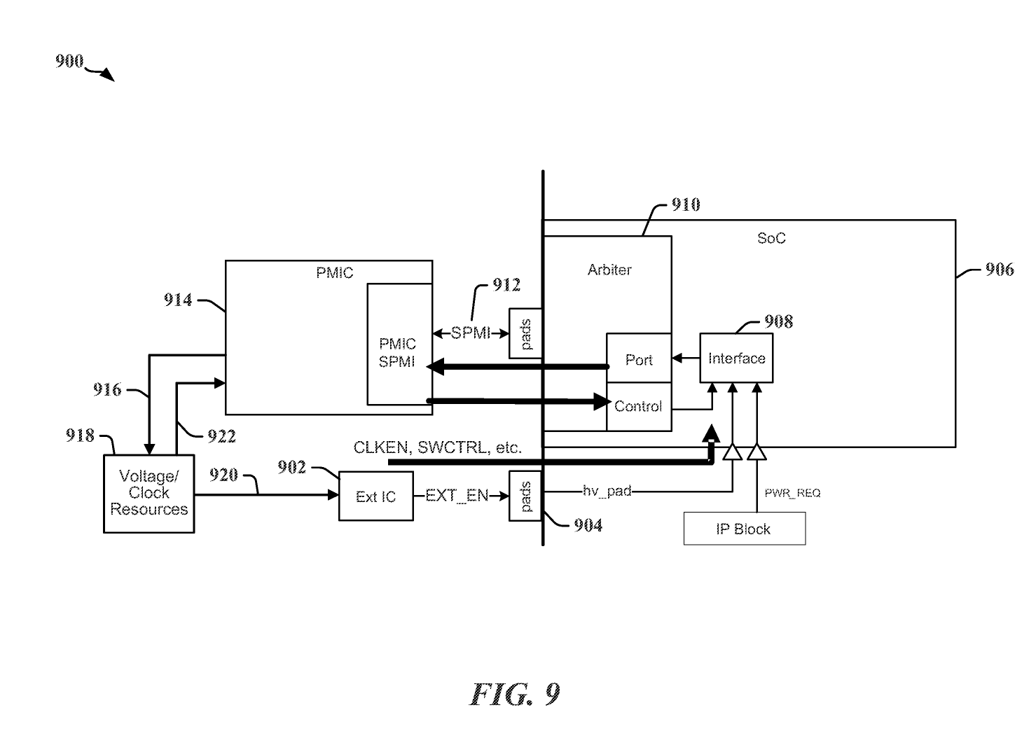

FIG. 9 is a diagram illustrating an example on-SoC architecture 900 for communicating signals between devices. In an example operation, an external IC (Ext IC) 902 (e.g., WiGig chip, wireless LAN chip, NFC chip, etc.) may send a control signal (e.g., clock enable (CLKEN) signal and/or switch control (SWCTRL) signal) to pads 904 on a SoC (e.g., Processor) 906. The pads 904 may be routed to an interface circuit/module 908. The interface circuit/module 908 may wake an always-on system in the SoC 906 and issue a command through a port of an arbiter circuit/module 910. The arbiter 910 may then send the command across a bus 912 (e.g., SPMI bus) to one or more PMICs 914. In an aspect, the command may be a global command to all of the PMICs or a command to a PMIC controller of a core PMIC that triggers a sequence of events. In a further aspect, although the bus 912 is shown as an SPMI bus in FIG. 9, it is contemplated that the command may be sent to the one or more PMICs 914 via any type of interface protocol (e.g., RFFE, I3C, I2C, PCIe, VGI, etc.). Notably, the external IC 902 does not have access to the bus 912.

In an aspect, the interface circuit/module 908 is a conversion engine that converts a hardware signal transition into a message that can be sent over the SPMI bus 912. The interface circuit/module 908 operates in conjunction with the arbiter 910, which is an interface to the bus 912. For example, the interface circuit/module 908 provides sufficient information to translate a hardware signal transition into an address and data pair that is sent to the arbiter 910 to send over the SPMI bus 912. The interface circuit/module 908 effectively takes a rising/falling signal edge and translates the rising/falling signal edge into a bitstream (protocol message) that can be sent over the bus 912.

In an aspect, more than one command may sent over the SPMI bus 912. As described above, the interface circuit/module 908 converts a hardware signal transition into a single message transmitted on the bus 912. However, in other aspects, the interface circuit/module 908 may convert the hardware signal transition into multiple messages transmitted on the bus 912.

In a further aspect, a requesting PMIC may send a command (e.g., EUD, BatAlarm) to the interface circuit/module 908 via the arbiter 910 using the SPMI bus 912. For example, if the requesting PMIC detects a USB plug event or a battery removal event, the requesting PMIC may request that a particular action (e.g., voltage regulator/clock control) be performed by one of the one or more PMICs 914. Accordingly, the requesting PMIC may make the request by sending an SPMI interrupt signal to a control circuit/module on the arbiter 910 that then triggers, based on pattern matching, an interrupt that goes into the interface circuit/module 908. Based on the interrupt from the arbiter 910, the interface circuit/module 908 may operate in the same way as with the control signal from the external IC 902. That is, the interface circuit/module 908 may take a rising/falling signal edge from the interrupt and translate the rising/falling signal edge into a bitstream to be sent over the SPMI bus 912 and back to the one or more PMICs 914 where the requested action may be performed.

In an aspect, a host processor of the SoC 906 may be in a low power/sleep state. Accordingly, aspects of the present disclosure relate to the interface circuit/module 908 staying powered-on to process control signals without waking the host processor. The control signals capable of being processed by the interface circuit/module 908 may be used to control and power on/off resources at the PMICs without waking the host processor. In an aspect, the interface circuit/module 908 resides on the SoC 906. Nonetheless, the host processor does not have to be awake in order for the interface circuit/module 908 to perform the control signal processing. The interface circuit/module 908 performs operations in accordance with the aspects of the present disclosure while the host processor is asleep.

In an aspect, waking of the host processor is avoided to mitigate a power penalty. For example, when the host processor is awake, the host processor may perform other actions/services unrelated to the communication of control signaling between external chips and PMICs (e.g. PMIC requesting its clock). As such, unnecessary device power is drained when the host processor is unnecessarily awake to perform the unrelated collateral actions. The present disclosure promotes power savings by providing the interface circuit/module 908, which remains awake to perform the novel operations of the present disclosure while keeping the host processor asleep (or in a low power state).

In an aspect of the disclosure, one or more rails 916 may connect the one or more PMICs 914 to voltage/clock resources 918. Moreover, one or more power rails 920 may connect the voltage/clock resources 918 to the external IC 902. When the arbiter 910 sends the command across the SPMI bus 912 to a PMIC 914, the PMIC 914 may perform a requested action according to the command For example, if the command is a request from the external IC 902 to enable a voltage regulator/clock, the PMIC 914 may enable a voltage regulator/clock buffer 918 corresponding to the external IC 902 based on the external IC's resource requirements via the one or more rails 916. Thereafter, a signal corresponding to the enabled regulator/clock may be sent to the external IC 902 via the one or more power rails 920. The external IC 902 may request that the resources 918 be enabled/disabled on the external IC's own timeline.

In a further aspect of the disclosure, one or more other power rails 922 may connect the voltage/clock resources 918 back to the one or more PMICs 914. When the arbiter 910 sends the command across the SPMI bus 912 to a PMIC 914, the PMIC 914 may perform a requested action according to the command For example, if the command is a request from a particular PMIC to enable a voltage regulator/clock, the one or more PMICs 914 may enable a voltage regulator/clock buffer 918 corresponding to the particular PMIC based on the particular PMIC' s resource requirements via the one or more rails 916. Thereafter, a signal corresponding to the enabled regulator/clock may be sent to the particular PMIC via the one or more other power rails 922.

Aspects of the present disclosure are novel and innovative for a number of reasons. For example, aspects of the present disclosure reduce a number of GPIO pins in a PMIC subsystem. Moreover, aspects of the present disclosure allow flexibility in transmitting a command/message over the bus 912. The command/message may be transmitted using any of a number of different protocols, e.g., SPMI, I2C, I3C, UART, VGI, SPI, etc. Also, aspects of the present disclosure may be implemented to support a sequence of messages for more complex control. Aspects of the present disclosure further allow messages to be sent to multiple end points using one control signal. Aspects of the present disclosure may also provide reduced PMIC cost, reduced PMIC pin count and associated package area, and reduced PCB signal routes.

Examples of a Method and Processing Circuit

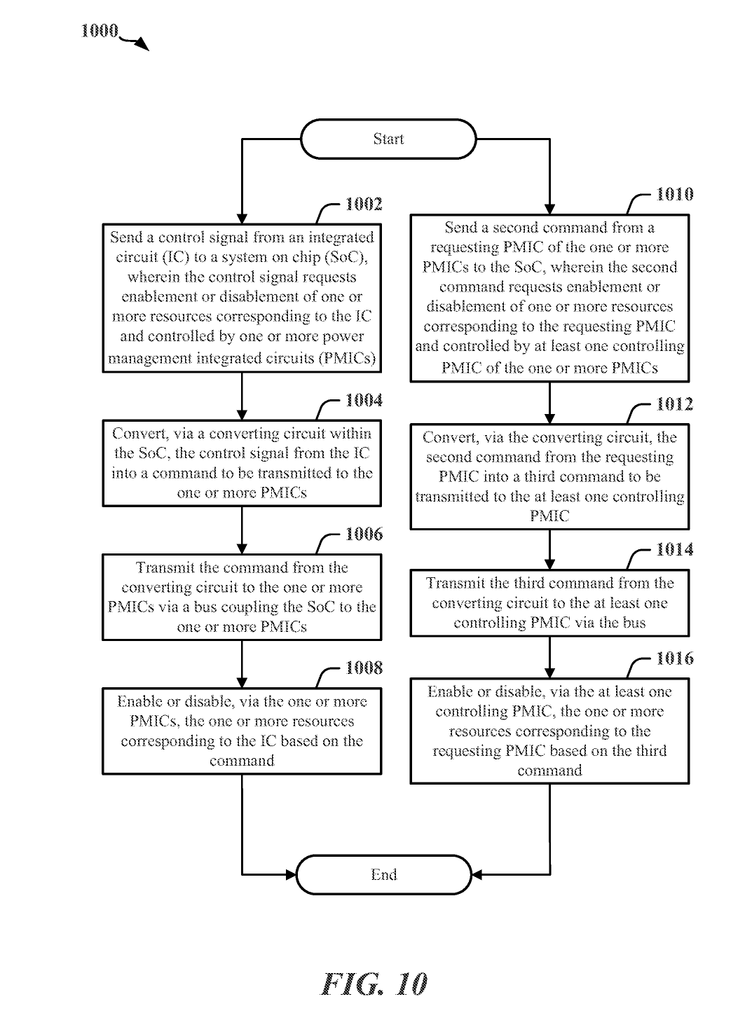

FIG. 10 is a flowchart 1000 of a method that may be performed at an apparatus (e.g., slave or bus master) for communicating a control signal between device components.

At block 1002, the apparatus may send a control signal from an integrated circuit (IC) to a system on chip (SoC). The control signal may request enablement or disablement of one or more resources corresponding to the IC and controlled by one or more devices (e.g., one or more power management integrated circuits (PMICs)). In an aspect, requesting enablement or disablement of the one or more resources may include a request for a feature adjustment, such as for example, a mode change, a state change, a voltage change, a clock signal, a pulse density modulation (PDM) output pattern change, and/or a noise spreading circuit. In an aspect, the IC is a circuit external to the SoC. In another aspect, the IC includes the one or more PMICs. Moreover, the one or more resources may include a voltage regulator regulating a voltage of the IC and/or a clock buffer providing a clock signal to the IC.

At block 1004, the device may convert, via a converting circuit within the SoC, the control signal from the IC into a command to be transmitted to the one or more PMICs. In an aspect, the converting circuit converts the control signal into the command while a host processor of the SoC is in a sleep or low power state. In a further aspect, the converting circuit converts the control signal into the command by translating a signal transition (e.g., rising edge or falling edge) of the control signal into a stream of bits representing the command

At block 1006, the device may transmit the command from the converting circuit to the one or more PMICs via a bus coupling the SoC to the one or more PMICs. In an aspect, the IC has no direct access to the bus. In another aspect, the IC is coupled to the bus and includes the one or more PMICs. In a further aspect, the command is transmitted from the converting circuit to the one or more PMICs via an arbiter that provides access to the one or more PMICs. In another aspect, the command is transmitted via the bus according to a system power management interface (SPMI) protocol or any other type of interface protocol (e.g., RFFE, I3C, I2C, PCIe, VGI, etc.). In a further aspect, the command transmitted via the bus is a stream of bits that may be encrypted or encoded (e.g., to disguise data for security purposes or to change an energy profile for noise considerations).

In an aspect, the command may be a single message, or multiple messages, transmitted on the bus. In another aspect, the command may be a global command transmitted to all PMICs of the one or more PMICs or a command transmitted to a core PMIC of the one or more PMICs. The core PMIC may include a PMIC controller configured to route the command to at least one PMIC of the one or more PMICs intended to receive the command

At block 1008, the device may enable or disable, via the one or more PMICs, the one or more resources corresponding to the IC based on the command

Additionally or alternatively, the device may perform other operations, such as the operations depicted in blocks 1010 to 1016 of FIG. 10.

At block 1010, the device may send a second command from a requesting PMIC of the one or more PMICs to the SoC via the bus. The second command may request enablement or disablement of one or more resources corresponding to the requesting PMIC and controlled by at least one controlling PMIC of the one or more PMICs.

At block 1012, the device may convert, via the converting circuit, the second command from the requesting PMIC into a third command to be transmitted to the at least one controlling PMIC.

At block 1014, the device may transmit the third command from the converting circuit to the at least one controlling PMIC via the bus.

At block 1016, the device may enable or disable, via the at least one controlling PMIC, the one or more resources corresponding to the requesting PMIC based on the third command

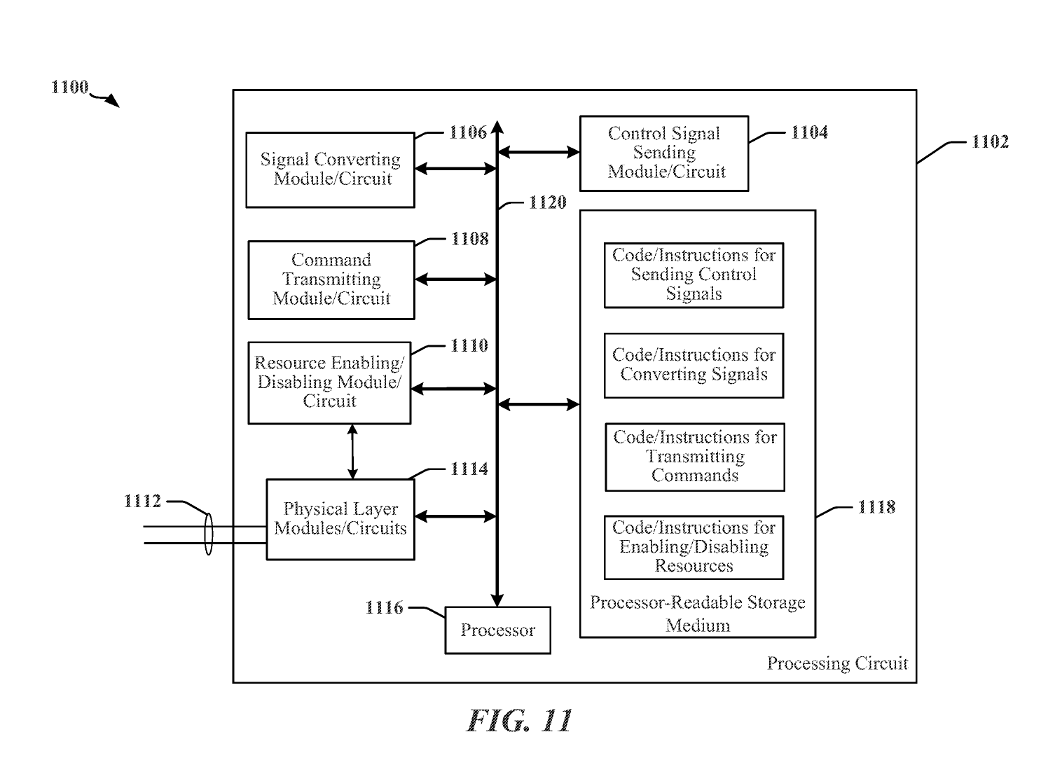

FIG. 11 is a diagram illustrating a simplified example of a hardware implementation for an apparatus 1100 employing a processing circuit 1102. The apparatus may implement a bridging circuit in accordance with certain aspects disclosed herein. The processing circuit typically has a controller or processor 1116 that may include one or more microprocessors, microcontrollers, digital signal processors, sequencers and/or state machines. The processing circuit 1102 may be implemented with a bus architecture, represented generally by the bus 1120. The bus 1120 may include any number of interconnecting buses and bridges depending on the specific application of the processing circuit 1102 and the overall design constraints. The bus 1120 links together various circuits including one or more processors and/or hardware modules, represented by the controller or processor 1116, the modules or circuits 1104, 1106, 1108, and 1110 and the processor-readable storage medium 1118. One or more physical layer circuits and/or modules 1114 may be provided to support communications over a communication link implemented using a multi-wire bus 1112 or other communication structure. The bus 1120 may also link various other circuits such as timing sources, peripherals, voltage regulators, and power management circuits, which are well known in the art, and therefore, will not be described any further.

The processor 1116 is responsible for general processing, including the execution of software, code and/or instructions stored on the processor-readable storage medium 1118. The processor-readable storage medium may include a non-transitory storage medium. The code and/or instructions, when executed by the processor 1116, causes the processing circuit 1102 to perform the various functions described supra (e.g., the functions described with respect to FIGS. 8, 9, and 10) for any particular apparatus. The processor-readable storage medium may be used for storing data that is manipulated by the processor 1116 when executing software. The processing circuit 1102 further includes at least one of the modules/circuits 1104, 1106, 1108, and 1110. The modules/circuits 1104, 1106, 1108, and 1110 may be software modules running in the processor 1116, resident/stored in the processor-readable storage medium 1118, one or more hardware modules coupled to the processor 1116, or some combination thereof. The modules/circuits 1104, 1106, 1108, and 1110 may include microcontroller instructions, state machine configuration parameters, or some combination thereof.

In one configuration, the apparatus 1100 includes modules and/or circuits 1104 configured to send control signals, modules and/or circuits 1106 configured to convert the control signals into commands to be transmitted to one or more PMICs, modules and/or circuits 1108 configured to transmit the commands to the one or more PMICs over a bus, and modules and/or circuits 1110 configured to enable or disable one or more resources via the one or more PMICs based on the commands

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed at an apparatus for communicating a control signal between device components, comprising:
sending a control signal from an integrated circuit (IC) to a system on chip (SoC), the control signal for requesting enablement or disablement of one or more resources corresponding to the IC;
converting, via a converting circuit within the SoC, the control signal from the IC into a command to be transmitted to one or more devices; and
transmitting the command from the converting circuit to the one or more devices via a bus coupling the SoC to the one or more devices.

2. The method of claim 1, wherein the IC is a circuit external to the SoC.

3. The method of claim 1, wherein the requesting enablement or disablement of the one or more resources includes at least one of:
a request for a voltage change;
a request for a clock signal;
a request for a mode change; or
a request for a state change.

4. The method of claim 1, wherein the command is:
a single message transmitted on the bus; or
multiple messages transmitted on the bus.

5. The method of claim 1, wherein the command is transmitted via the bus according to a system power management interface (SPMI) protocol.

6. The method of claim 1, wherein the converting circuit is configured to convert the control signal into the command while a host processor of the SoC is in a sleep or low-power state.

7. The method of claim 1, wherein the converting circuit is configured to convert the control signal into the command by translating a signal transition of the control signal into a stream of bits representing the command

8. The method of claim 1, wherein the one or more devices includes one or more power management integrated circuits (PMICs) configured to control the one or more resources, the method further including:
enabling or disabling, via the one or more PMICs, the one or more resources corresponding to the IC based on the command

9. The method of claim 8, wherein the IC includes the one or more PMICs.

10. The method of claim 8, wherein the command is transmitted from the converting circuit to the one or more PMICs via an arbiter that provides access to the one or more PMICs.

11. The method of claim 8, wherein the command is:
a global command transmitted to all PMICs of the one or more PMICs; or
a command transmitted to a core PMIC of the one or more PMICs, wherein the core PMIC includes a PMIC controller for routing the command to at least one PMIC of the one or more PMICs intended to receive the command

12. The method claim 8, further including:
sending a second command from a requesting PMIC of the one or more PMICs to the SoC via the bus, the second command for requesting enablement or disablement of one or more resources corresponding to the requesting PMIC and controlled by at least one controlling PMIC of the one or more PMICs;
converting, via the converting circuit, the second command from the requesting PMIC into a third command to be transmitted to the at least one controlling PMIC;
transmitting the third command from the converting circuit to the at least one controlling PMIC via the bus; and
enabling or disabling, via the at least one controlling PMIC, the one or more resources corresponding to the requesting PMIC based on the third command

13. An apparatus for communicating a control signal between device components, comprising:
one or more devices;
a system on chip (SoC);
a bus coupling the SoC to the one or more devices;
an integrated circuit (IC) configured to send a control signal to the SoC, the control signal for requesting enablement or disablement of one or more resources corresponding to the IC; and
a converting circuit formed within the SoC and configured to convert the control signal from the IC into a command and transmit the command to the one or more devices via the bus.

14. The apparatus of claim 13, wherein the IC is a circuit external to the SoC.

15. The apparatus of claim 13, wherein the one or more resources includes at least one of:
a voltage regulator regulating a voltage of the IC;
a clock buffer providing a clock signal to the IC;
a mode change; or
a state change.

16. The apparatus of claim 13, wherein the command is:
a single message transmitted on the bus; or
multiple messages transmitted on the bus.

17. The apparatus of claim 13, wherein the command is transmitted via the bus according to a system power management interface (SPMI) protocol.

18. The apparatus of claim 13, wherein the converting circuit is configured to convert the control signal into the command while a host processor of the SoC is in a sleep or low-power state.

19. The apparatus of claim 13, wherein the converting circuit is configured to convert the control signal into the command by translating a signal transition of the control signal into a stream of bits representing the command

20. The apparatus of claim 13, wherein the one or more devices includes one or more power management integrated circuits (PMICs) configured to control the one or more resources,
wherein the one or more PMICs enable or disable the one or more resources corresponding to the IC based on the command

21. The apparatus of claim 20, wherein the IC includes the one or more PMICs.

22. The apparatus of claim 20, wherein the converting circuit is configured to transmit the command to the one or more PMICs via an arbiter configured to provide access to the one or more PMICs.

23. The apparatus of claim 20, wherein the command is:
a global command transmitted to all PMICs of the one or more PMICs; or
a command transmitted to a core PMIC of the one or more PMICs, wherein the core PMIC includes a PMIC controller configured to route the command to at least one PMIC of the one or more PMICs intended to receive the command

24. The apparatus claim 20, wherein:
a requesting PMIC of the one or more PMICs is configured to send a second command to the SoC via the bus, the second command for requesting enablement or disablement of one or more resources corresponding to the requesting PMIC and controlled by at least one controlling PMIC of the one or more PMICs;
the converting circuit is configured to convert the second command from the requesting PMIC into a third command and transmit the third command to the at least one controlling PMIC via the bus; and
the at least one controlling PMIC is configured to enable or disable the one or more resources corresponding to the requesting PMIC based on the third command.

25. An apparatus for communicating a control signal between device components, comprising:
means for sending a control signal from an integrated circuit (IC) to a system on chip (SoC), the control signal for requesting enablement or disablement of one or more resources corresponding to the IC;
means for converting, within the SoC, the control signal from the IC into a command to be transmitted to one or more devices; and
means for transmitting the command from the means for converting to the one or more devices via a bus coupling the SoC to the one or more devices.

26. The apparatus of claim 25, wherein the means for converting is configured to convert the control signal into the command while a host processor of the SoC is in a sleep or low-power state.

27. The apparatus of claim 25, wherein the one or more devices includes one or more power management integrated circuits (PMICs) configured to control the one or more resources, the apparatus further including:
means for enabling or disabling, via the one or more PMICs, the one or more resources corresponding to the IC based on the command

28. A non-transitory computer-readable medium storing computer-executable code at an apparatus for communicating a control signal between device components, comprising code for causing a computer to:
send a control signal from an integrated circuit (IC) to a system on chip (SoC), the control signal for requesting enablement or disablement of one or more resources corresponding to the IC;
convert, within the SoC, the control signal from the IC into a command to be transmitted to one or more devices; and
transmit the command to the one or more devices via a bus coupling the SoC to the one or more devices.

29. The non-transitory computer-readable medium of claim 28, wherein the code for causing the computer to convert is configured to convert the control signal into the command while a host processor of the SoC is in a sleep or low-power state.

30. The non-transitory computer-readable medium of claim 28, wherein the one or more devices includes one or more power management integrated circuits (PMICs) configured to control the one or more resources, the non-transitory computer-readable medium further including code for causing the computer to:
enable or disable, via the one or more PMICs, the one or more resources corresponding to the IC based on the command.
